(19) United States
(12) Patent Application Publication
(10) Pub. No.: US 2006/0015695 A1
(43) Pub. Date: Jan. 19, 2006

(54) Method of device mirroring via packetized networking infrastructure

(76) Inventors: Robert Alan Cochran, Sacramento, CA (US); Krishna Babu Puttagunta, Roseville, CA (US); Ralph Rudolph Lobato, Coquille, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/879,401

(22) Filed: Jun. 30, 2004

(51) Int. Cl. G06F 12/16

(52) U.S. Cl. 711/162

(57) ABSTRACT

A method of device-mirroring via a packetized networking infrastructure may include: receiving, at a storage node N in a daisy-chained architecture, a write command from an entity representing a node N−1 in the daisy-chained architecture; representing the write command as an original set of one or more packets; making M copies of each packet of the original set; sending each packet of the original set to a storage node N+1 in the daisy-chained architecture via the networking infrastructure; and sending the M copies of each packet in the original set to the storage node N+1 via the networking infrastructure.

### BACKGROUND OF THE PRESENT INVENTION

It is common practice in many industries to provide a backup data storage entity. In critical applications and industries, host entities often have multiple data storage entities coupled through a controller to a computer and operated in a mirrored (also known as shadowed) configuration. In a mirrored configuration, data storage entities are treated as pairs. All data intended for a primary member of the pair is duplicated on a block-for-block basis on the secondary or “mirrored” member of the pair.

One type of mirroring architecture is asynchronous mirroring. Using asynchronous mirroring, once a write command (hereafter referred to as a “WRT”) is received at a primary storage entity, a completion acknowledgment is sent directly back to an originating host entity to indicate that a subsequent WRT may be sent. However, this acknowledgment may not necessarily indicate that the WRT was received at (or even yet transmitted to) a secondary storage entity. Instead, if the WRT is placed in the buffer of the primary storage entity, then the WRT is issued a sequence number indicating its position in relation to the other WRTs stored in the buffer. Subsequently, the WRT can be forwarded to the secondary storage entity.

Another type of mirroring is synchronous mirroring. In contrast to asynchronous mirroring, a synchronous mirror primary storage entity delays sending acknowledgement (of having completed a WRT from the host entity) until the primary storage entity has received acknowledgement that the secondary storage entity has completed the WRT (that the primary storage entity had forwarded). Relative to asynchronous mirroring, synchronous mirroring delays the host from sending a second WRT until two storage entities (instead of merely one) in the chain have actually received a first WRT.

FIG. 1 is a block diagram of a cascaded (also known as daisy-chained) device-mirroring architecture 100 that uses a dedicated mirroring link, according to the Background Art.

Architecture 100 includes a host entity 102 in communication with a primary storage entity, e.g., disk array, 104. An array configuration and control PC (or, in other words, a controller) 106 for primary disk array 104 is depicted separately from primary disk array 104. Host entity 102 and controller 106 communicate via, e.g., an intranet 108 using, e.g., ESCON, ATM, DWDM, T3, FC (Fibre Channel), SCSI, etc . . .

Architecture 100 further includes a secondary storage entity, e.g., disk array, 112; another host entity 110 in communication with secondary disk array 104. For simplicity of illustration, a controller for secondary disk array 112 is not depicted separately from secondary disk array 112, but instead is considered integral therewith. Host entity 110 is connected, e.g., to an intranet 114 using, e.g., ESCON, ATM, DWDM, T3, FC (Fibre Channel), etc . . .

Host entity 102 exchanges a heartbeat signal with host entity 110 via intranet 108, a packetized (e.g., TCP/IP protocol) public networking infrastructure (or, in other words, LAN/WAN) 118 and intranet 114. Such a heartbeat signal is typically exchanged via a tunnel through LAN/WAN 118.

Device-mirroring data traffic, between primary disk array 104 and a secondary storage entity, e.g., disk array, 112 travels via at least one dedicated mirroring link 116, e.g., a leased line using, e.g., ESCON, ATM, DWDM, T3, FC (Fibre Channel), etc. Primary disk array 104 receives WPTs from host entity 102. Subsequently, primary disk array 104 forwards these WRTs to secondary disk array 112 via dedicated link 116. Dedicated link 116 can be expensive to establish and/or maintain.

To reduce the cost of architecture 100, dedicated mirroring link 116 was eliminated. Instead of ink 116, the device-mirroring data traffic is transmitted via LAN/WAN 118. FIG. 2A is a block diagram of such a daisy-chained device-mirroring architecture 200 that uses a mirroring link at least part of which includes a packetized and at-least-partially-public networking infrastructure 214, according to the Background Art.

Architecture 200 includes: a host entity 202; a primary storage entity, e.g., disk array, 204 having an integral controller; a packetized (e.g., TCP/IP protocol) networking infrastructure 214 such as an intranet or the internet; a secondary storage entity, e.g., disk array, 208; and another host entity 206. Arrays 204 and 208 include interfaces that can packetize a WRT into a set of one or more packets (e.g., convert FC to IP) and reconstruct a WRT from a set of one or more packets (e.g., convert IP to FC).

Device-mirroring data traffic between primary disk array 204 and secondary disk array 208 passes through a tunnel 210 in networking infrastructure 214. A heartbeat signal is exchanged between host entity 202 and host entity 206 via another tunnel 212 in networking infrastructure 214. Tunnels 210 and 212 behave as disjoint networks.

### SUMMARY OF THE PRESENT INVENTION

At least one embodiment of the present invention provides a method of device-mirroring via a packetized networking infrastructure. Such a method may include: receiving, at a storage node N in a daisy-chained architecture, a write command from an entity representing a node N−1 in the daisy-chained architecture; representing the write command as an original set of one or more packets; making M copies of each packet of the original set; sending each packet of the original set to a storage node N+1 in the daisy-chained architecture via the networking infrastructure; and sending the M copies of each packet in the original set to the storage node N+1 via the networking infrastructure.

Additional features and advantages of the invention will be more fully apparent from the following detailed description of example embodiments, the accompanying drawings and the associated claims.

### BRIEF DESCRIPTION OF THE DRAWINGS

The present invention will be described more fully with reference to the accompanying drawings, of which those not labeled “Background Art” depict example embodiments of the present invention. The accompanying drawings: should not be interpreted to limit the scope of the present invention; and not to be considered as drawn to scale unless explicitly noted.

FIG. 1 is a block diagram of a cascaded or daisy-chained device-mirroring architecture using a dedicated mirroring link, according to the Background Art.

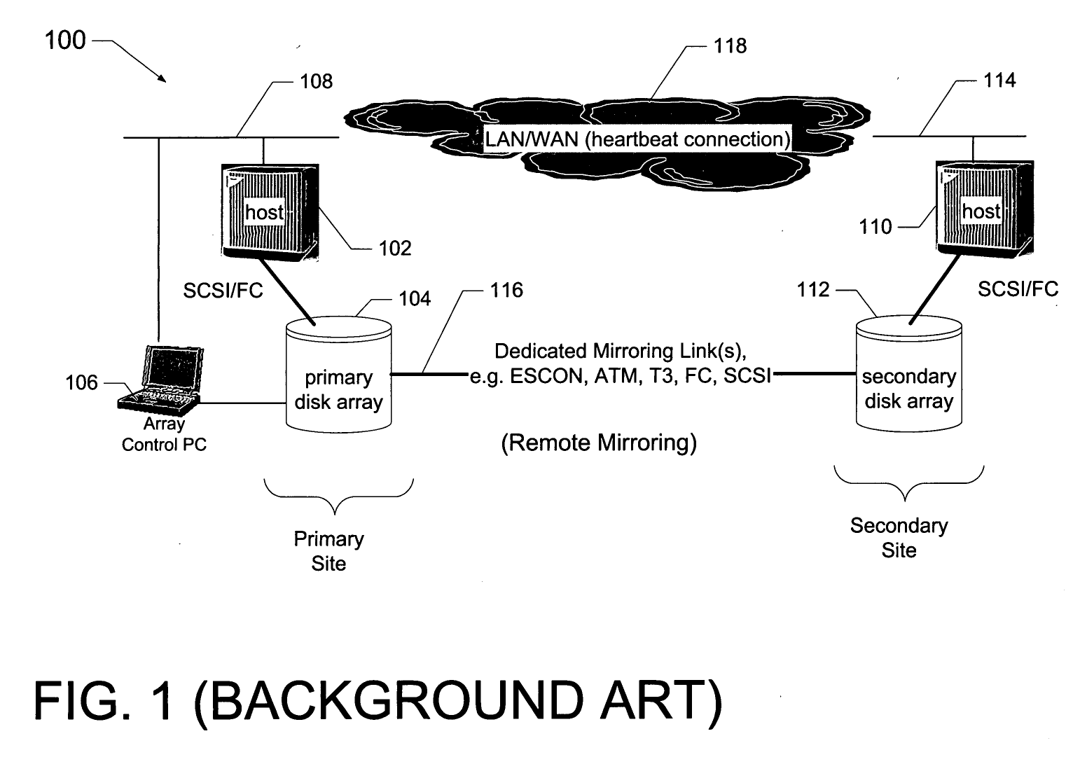

FIG. 2A is a block diagram of a cascaded or daisy-chained device-mirroring architecture using a mirroring link that includes a packetized public networking infrastructure, according to the Background Art.

FIG. 2B is a more detailed block diagram of the daisy-chained device-mirroring architecture of FIG. 2A, according to the Background Art.

FIG. 3 is a block diagram of a cascaded or daisy-chained device-mirroring architecture using a mirroring link that includes a packetized public networking infrastructure, according to at least one embodiment of the present invention.

FIG. 4 is a block diagram of version of the daisy-chained device-mirroring architecture of FIG. 3 extended to include another storage node, according to at least one embodiment of the present invention.

FIG. 5 is a UML-type sequence diagram of a redundacasting method of device mirroring via a packetized public networking infrastructure, according to at least one embodiment of the present invention. In a sequence diagram, → indicates an action that expects a response message. A [symbol] indicates a response message. A [symbol] indicates an action for which the response is implied. And a [symbol] indicates an action for which no response is expected.

FIG. 6 is a flowchart depicting a method of culling, according to at least one embodiment of the present invention.

### DETAILED DESCRIPTION OF EXAMPLE EMBODIMENTS

In developing the present invention, the following problem with the Background Art was recognized and a path to a solution identified.

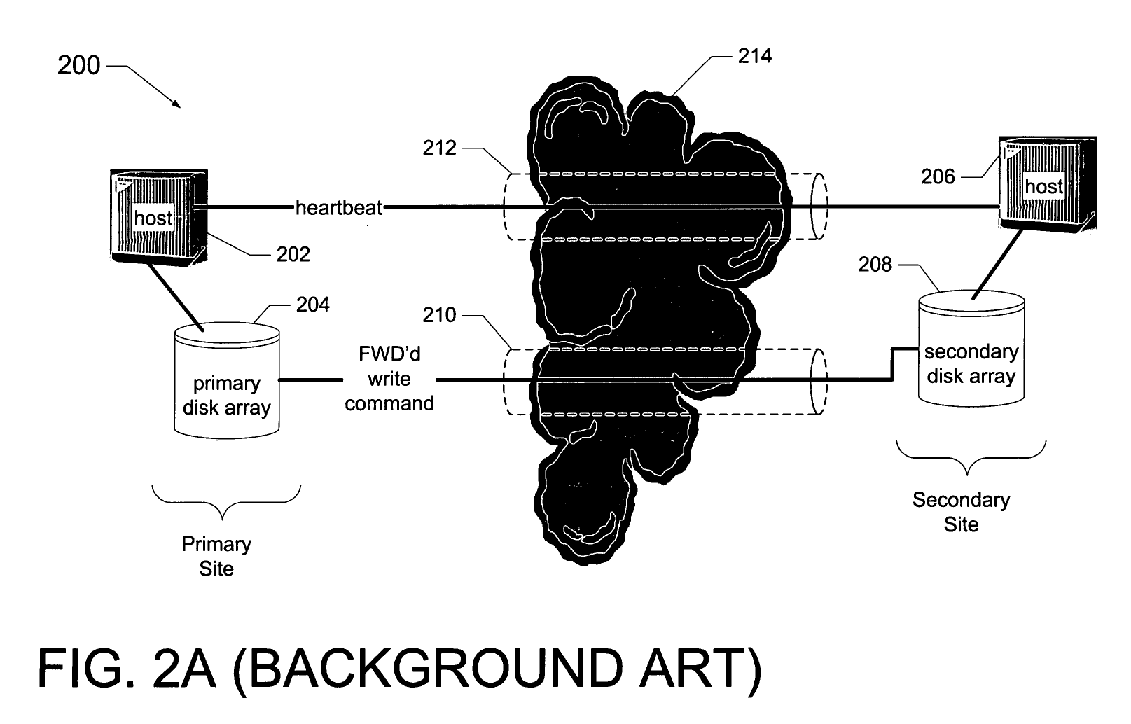

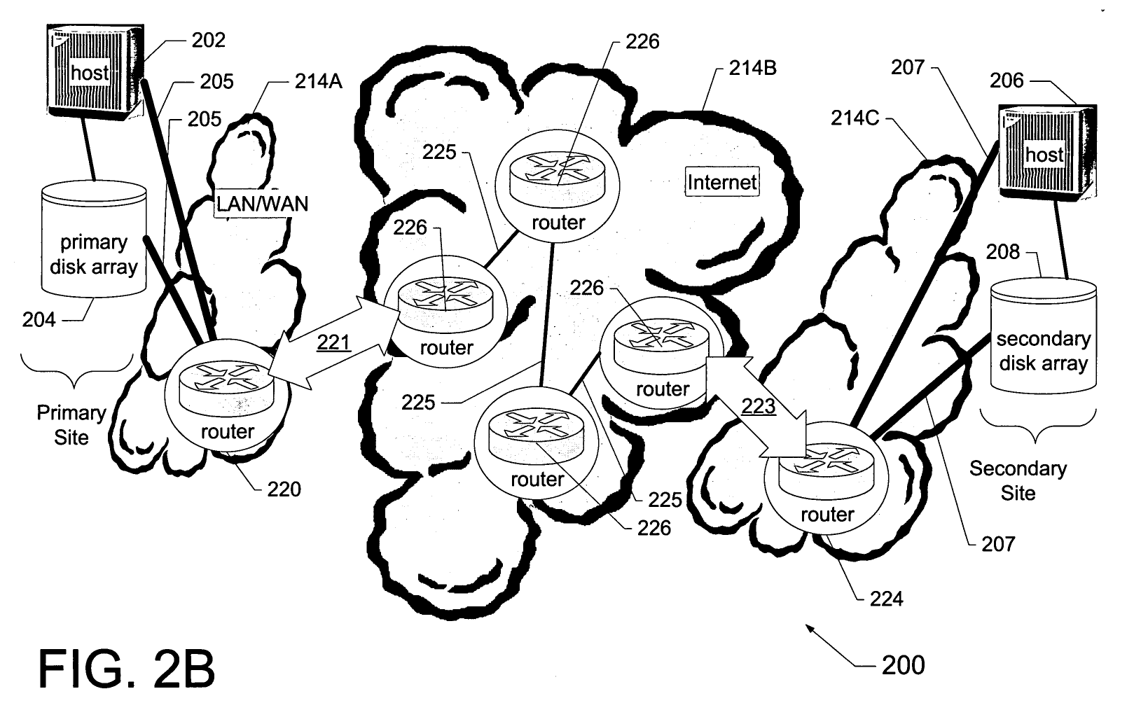

FIG. 2B is a more detailed block diagram of the daisy-chained device-mirroring architecture of Background Art FIG. 2A, albeit from the perspective of the present invention. Hence, FIG. 2B has not been labeled as Background Art. While tunnels 210 and 212 of FIG. 2A behave as disjoint networks, e.g., due to protocol encapsulation and/or encryption, they are disjoint only logically. In other words, Background Art FIG. 2A is a logical block diagram. In contrast, FIG. 2B is a physical diagram version of Background Art FIG. 2A.

In FIG. 2B, networking infrastructure 214 has been depicted in more detail as including a public networking infrastructure 214B, an optional private networking infrastructure 214A and another optional private networking infrastructure 214C. Public networking infrastructure 214B includes a plurality of physical links 225 (e.g., cables, a line-of-sight microwave connections, a glass fibers, etc.) and physical junctions (e.g., switches, hubs, routers, cable splices, etc.) 226 by which packets are transferred from one endpoint to another.

Similarly, private networking infrastructure 214A includes physical links 205 (although only one is depicted in FIG. 2B for simplicity) and physical junctions 220 (although only one is depicted in FIG. 2B for simplicity), e.g., a router. A physical link 221 connects private networking infrastructure 214A to public networking infrastructure 214B. Likewise, private networking infrastructure 214C includes physical links 207 (although only one is depicted in FIG. 2B for simplicity) and physical junctions 224 (although only one is depicted in FIG. 2B for simplicity), e.g., a router. A physical link 223 connects private networking infrastructure 214C to public networking infrastructure 214B.

Inspection of FIG. 2B reveals that tunnels 210 and 212 have a great likelihood of having one or more physical links 225 and physical junctions 226 in common. Moreover, the private networks (which tunnels 210 and 212 logically represent) have physical links 221 and 223 in common, and have a great likelihood that one or more physical links 205 & 207 and physical junctions 220 & 224 are common.

A temporary disruption in the common physical links and/or junctions temporarily interrupts arrival of, if not permanently destroys, a forwarded WRT sent from primary array 204 to secondary array 208. At least one embodiment of the present invention can accommodate such a temporary disruption without the need to track (at primary disk array 204) receipt (at secondary disk array 208) of the forwarded WRT.

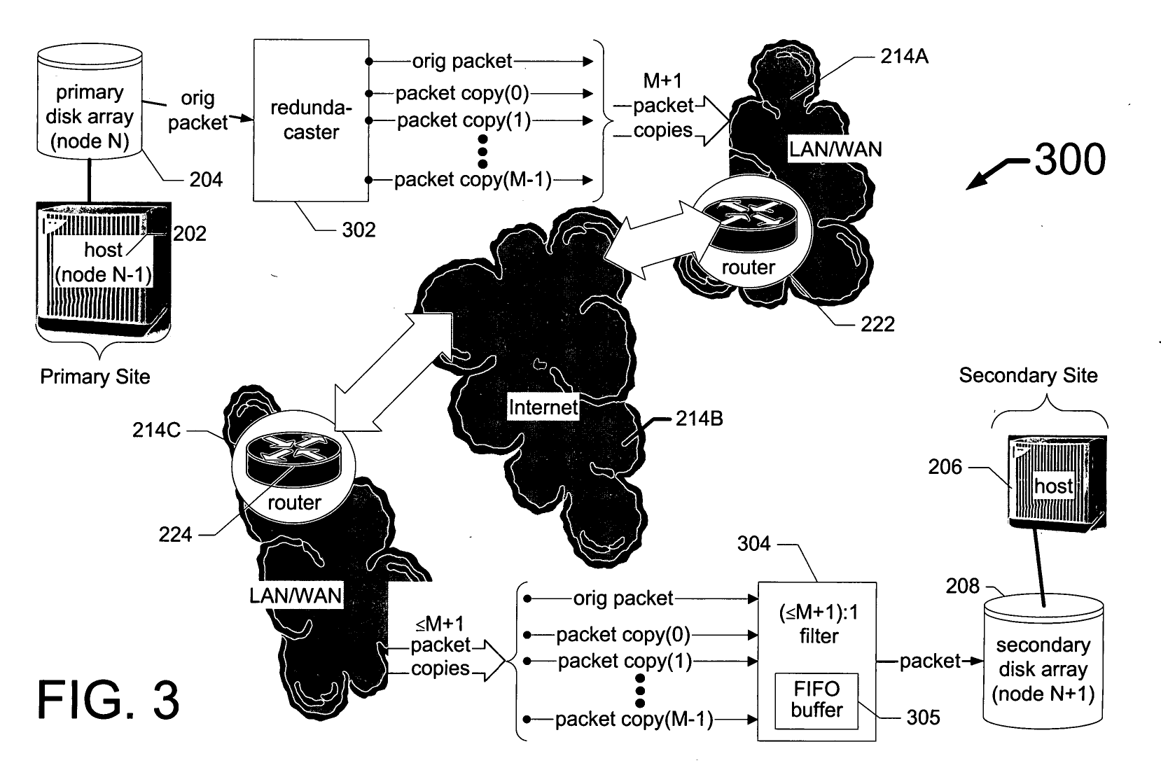

FIG. 3 is a block diagram of a cascaded or daisy-chained device-mirroring architecture 300 that uses a mirroring link that includes a packetized and at least partially public networking infrastructure, according to at least one embodiment of the present invention.

FIG. 3 is similar to FIG. 2B in some respects. Accordingly, such similarities will be treated briefly. Architecture 300 includes: host entities 202 and 206; a primary storage entity, e.g., disk array, 204; and a secondary storage entity, e.g., disk array, 208; public networking infrastructure, e.g., the internet, 214B; optional private networking infrastructure (or, in other words, LAN/WAN) 214A; and optional private networking infrastructure (or, in other words, IAN/WAN) 214C. Each of networking infrastructures 214A, 214B and 214C can use, e.g., TCP/IP protocol. Each of disk arrays 204 and 208 has: an integral controller; and interfaces that can packetize a WRT (again, a write command) into a set of one or more packets (e.g., convert FC to TCP/IP) and reconstruct a WRT from a set of one or more packets (e.g., convert TCP/IP to FC).

In contrast to Background Art architecture 200, architecture 300 further includes the following types of networking devices: redundant-casting device (redundacaster) 302; and a (≦M+1:1)) filter 304 (which can itself include a buffer, e.g., FIFO-type, 305 discussed below.

Briefly as to operation, primary array 204 forwards a WRT to secondary array 208, where the forwarded WRT takes the form of a set of one or more packets. In response, redundacaster 302 can: receive the set of packets (let's call it the original set) representing the forwarded WRT from primary disk array 204; make M copies of the original packet set; send the original packet set to secondary disk array 208 via LAN/WAN 214A (if present), internet 214B and LAN/WAN 214C (if present); and send the M packet set copies to secondary disk array 208 via LAN/WAN 214A (if present), internet 214B and LAN/WAN 214C (if present).

A note about terminology. The term redundacast is adopted herein, for the following reasons. Redundacaster 302 does not multicast. Nor are the M+1 packet sets sent by redundacaster 302 considered to be M+1 unicasts because the content of the M+1 packet sets is the same. Hence, a redundacast should be understood as a unicast is redundantly performed. As will be discussed in more detail below, a redundacast can send respective packet sets via distinctive separate tunnels having at least one physical difference (e.g., links and junctions).

Such separate tunnels having at least one physical difference can be achieved, e.g., via a difference in the points in time at which transmission is initiated. In a packetized networking infrastructure, routing is temporally adaptive based upon conditions in the infrastructure at the time that a next hop taken by a packet is being determined. Accordingly, successive transmissions between two endpoints tend to follow the same physical path unless later-transmitted packets encounter circumstances (e.g., congestion or lack thereof, temporary failure or lack thereof, etc.) not encountered by earlier-transmitted packets. As a practical matter, packets that otherwise are the same can travel separate tunnels having at least one physical difference if the points in time at which the packets are transmitted are different. The greater the differences in time at which transmission is initiated, the greater the probability that the separate tunnels through which the packets travel will have at least one physical difference—particularly if a networking infrastructure failure occurs.

The operation of filter 304, in response to redundacaster 302, is now briefly described. Filter 304 can receive, via LAN/WAN 214A (if present), internet 214B and LAN/WAN 214C (if present), a plurality of packets that correspond to M+1 or fewer copies of the original packet set sent by redundacaster 302, where one of the packet set copies might be the original packet set. Then filter 304 can: cull one complete set from the plurality of received packets; send the complete set to secondary storage array 208; and discard the remainder of the plurality of packets. Secondary storage array 208 can reconstruct the forwarded write command from the complete set.

In FIG. 3, filter 304 is labeled “(≦M+1:1)) filter.” This is done to reflect the possibility, that fewer than M+1 packet copy sets might arrive successfully at filter 304.

For redundacaster 302 and filter 304, M can be any size. But 2≦M≦32 is a typical range for commercial equipment. As a practical matter, the size of M depends upon the risk tolerance of the network administrator. A smaller value of M might be used by a more risk tolerant network administrator because it results in less network traffic due to fewer redundant copies of the WRT being sent. On the other hand, a larger value of M might be used by a risk averse network administrator who is willing to suffer greater network traffic (because there is a greater number of redundant copies of the WRT being sent) for the increased data security provided by the greater redundancy.

Redundacaster 302 can make all M packet set copies at substantially the same time and send them all at substantially the same time, e.g., immediately after sending the original packet set or after a delay. Alternatively, redundacaster 302 can iteratively make a packet copy set k+1 of packet set k and then send set k after a fixed or random delay. Such iteration could continue until k=M+1.

In architecture 300, the probability that a WRT will arrive at secondary array 208 is relatively high (proportional to the size of M). As such, primary array 208 is configured to send an acknowledgement (ACK) back to host entity 202 that secondary array 208 has completed a WRT without primary array 208 actually having received an ACK from secondary array 208. Instead of receiving an ACK from secondary array 208, primary array 204 assumes receipt of the forwarded WRT given the high probability that receipt will occur. Accordingly, primary array 204 can send an ACK back to host entity 202 as soon as the original packet set (again, representing the forwarded WRT) and the M packet set copies are sent by redundacaster 302. Host entity 202 can defer sending the next WRT, namely WRT(k+1), until it receives ACK(k) for the previous WRT, WRT(k). This is substantially a synchronous-mirroring arrangement, which can be described as semi-synchronous-mirroring.

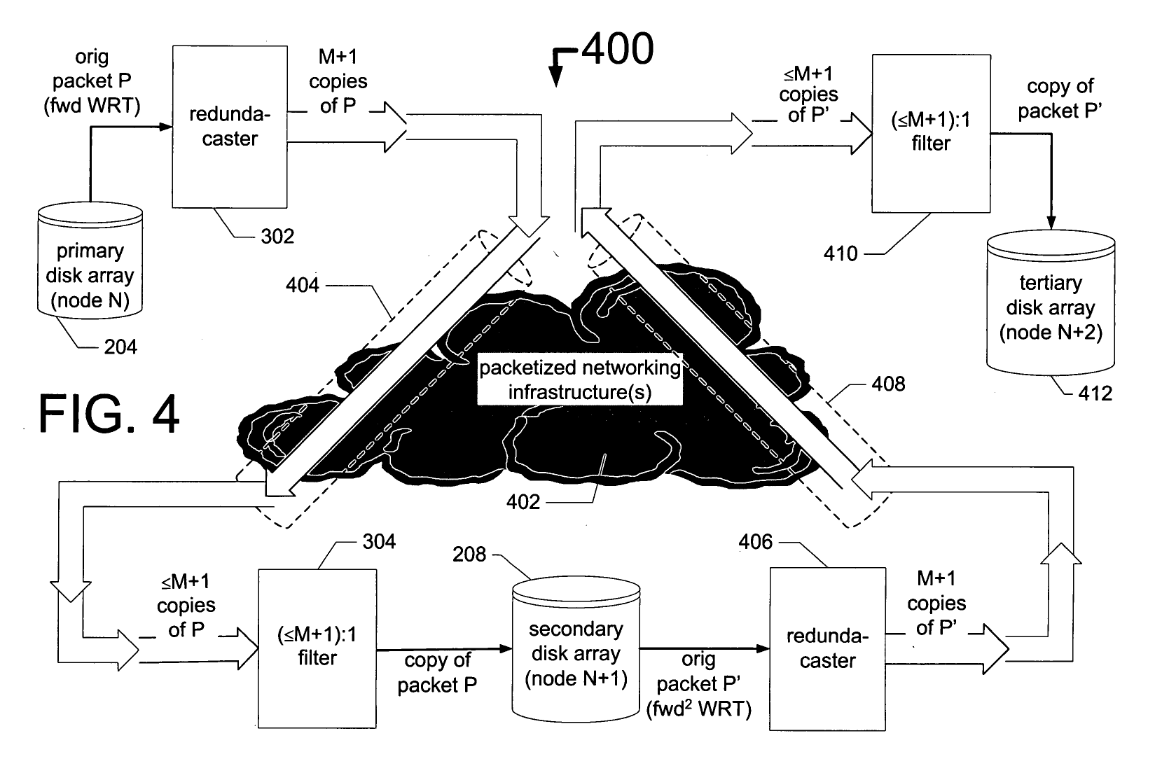

FIG. 4 is a block diagram of a version of the daisy-chained device-mirroring architecture of FIG. 3 extended to include another storage node, according to at least one embodiment of the present invention.

In FIG. 4, architecture 400 includes: primary disk array 204; redundacaster 302; packetized networking infrastructure 402 corresponding to infrastructures 214A, 214B and/or 214C; filter 304; secondary array 208; another redundacaster 406 connected to secondary array 208; another (≦M+1:1)) filter 410; and a tertiary storage entity, e.g., disk array 412. In the daisy-chain that architecture 400 represents, primary array 204 can be considered as node N, more particularly storage node N. Similarly, secondary array 208 can be considered storage node N+1, and tertiary array 412 can be considered storage node N+2. If host entity 202 were depicted in FIG. 4, it could be considered node N−1.

Storage node N+1 has a relationship with storage node N+2 that is similar to the relationship that storage node N has with storage node N+1. Redundacaster 406 operates similarly to redundacaster 302. Filter 410 operates similarly to filter 304. Storage node N forwards WRTs to storage node N+1 via redundacaster 302, tunnel 404 in networking infrastructure 402 and filter 304. Storage node N+1 forwards WRTs to storage node N+2 via redundacaster 406, tunnel 408 in networking infrastructure 402 and filter 410.

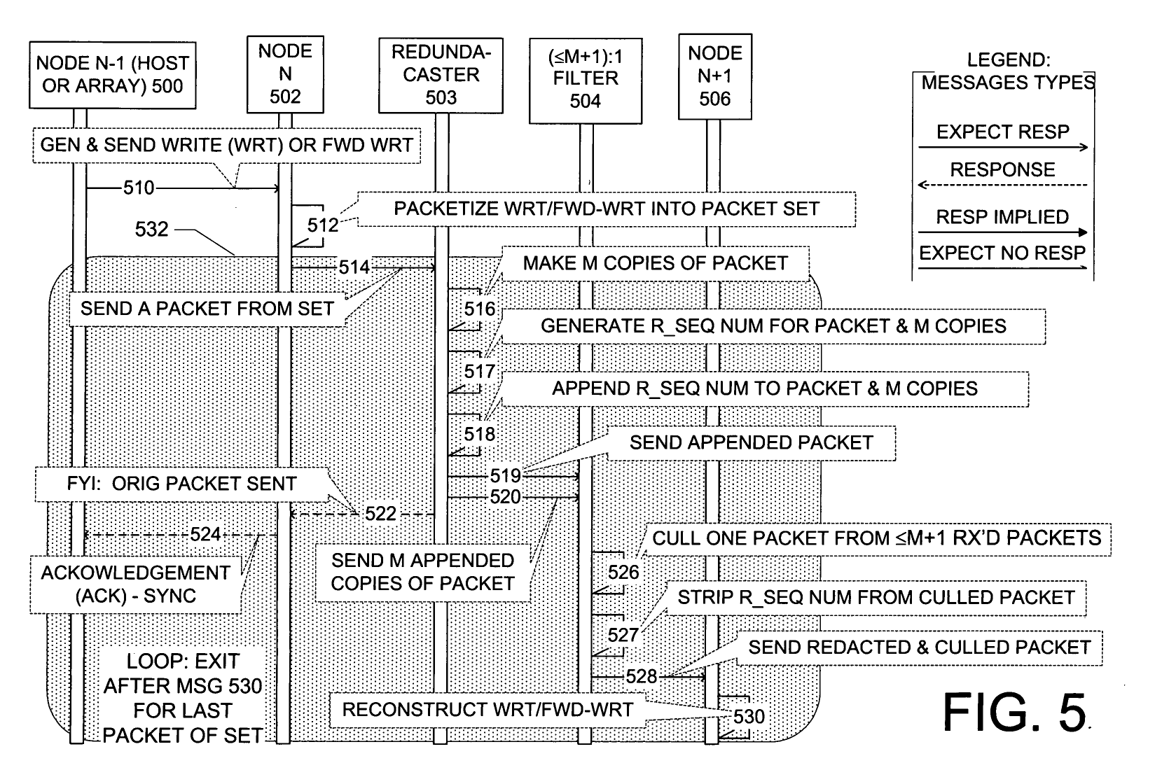

FIG. 5 is a UML-type sequence diagram of a redundacasting method of device mirroring via a packetized public networking infrastructure, according to at least one embodiment of the present invention. FIG. 5 depicts the following components: unit 500 representing a node N−1 that can be either a host entity such as host entity 202 or a storage node such as arrays 204 and 208; a unit 502 representing a node N such as primary array 204 or secondary array 208 which (again) are capable of generating packetized traffic; a redundacaster 503 such as redundacaster 302; a (≦M+1:1)) filter 504 such as filter 304; and a unit 506 representing a node N+1 such as secondary array 208.

In FIG. 5, at message 510, node N−1 (500) either generates and sends a WRT or forwards a WRT. At self-message 512, node N (502) packetizes the WRT/forwarded-WRT into a packet set. At message 514, node N (502) sends one packet of the set towards its ultimate destination of node N+1 (506), though the next stop on the path of the packet set called out in FIG. 5 is redundacaster 503.

At self-message 516, redundacaster 503 makes M copies of the packet. At self-message 517, redundacaster 503 generates a temporally-unique (or, in other words, not recently used) redundacast sequence (R_Seq) number (to be discussed further below) for the packet and it's copies. At self-message 518, redundacaster 503 appends the R_Seq number to the packet and its M copies, respectively.

At message 519, redundacaster 503 sends the appended original packet towards its ultimate destination of node N+1 (506), though the next stop on the path of the packet called out in FIG. 5 is filter 504. At message 520, redundacaster 503 sends the M appended packet copies towards their ultimate destination of node N+1 (506), though the next stop on the path of the packet sets called out in FIG. 5 is filter 504. As noted above, there are many different ways to implement how the sets are sent at messages 518-520.

In the case where node N−1 (500) is a host entity, then optional messages 522-524 would be included. At message 522, redundacaster 503 notifies node N (502) that the original packet has been sent (see message 514) to node N+1 (506). Node N (502) (and any other nodes upstream thereof) can be kept unaware of the redundacasting performed by redundacaster 503. At message 524, node N (502) sends an ACK to node N−1 (500) regarding the WRT of message 510.

At self-message 526, filter 504 culls one packet from the plurality of packets (≦M+1) that it receives as a result of messages 518-520. Culling includes determining when a later-received packet is redundant to an earlier-received packet.

As to recognizing packet redundancy, redundacaster 503 assigns each packet it receives an R_Seq (again, redundacast sequence) number. Such numbering can be similar to the known sequence numbering of forwarded writes performed by a primary array, e.g., 304. Redundacaster 503 appends the R_Seq number to the original packet and its M copies as part of the respective packet's metadata. For example, a byte sequence (or, in other words, a bit pattern) can be established as a marker for which filter 504 can search in a packet's metadata. Upon finding the marker appended to the packet originating from 502, filter 504 can be configured to treat a subsequent number of bytes, e.g., 4, as the R_Seq number. After filter 504 receives a packet having a given R_Seq number, then it can discard as redundant any other received packets having the same R_Seq number.

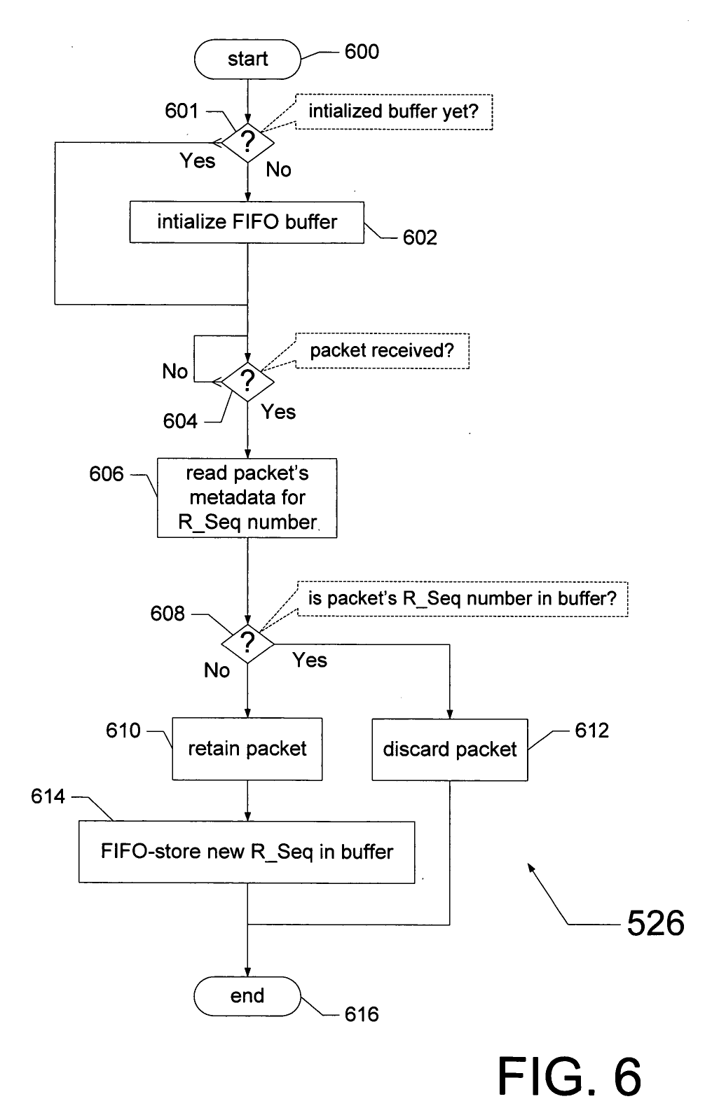

FIG. 6 is a flowchart depicting a method of culling, according to at least one embodiment of the present invention, e.g., that can be performed by filter 504 at message 526. Flow begins at block 600 and proceeds to block 601, where it is determined if a tool to track recently received R_Seq numbers has been initialized. Such a tool can be FIFO buffer 305. Like other sequence numbers, R_Seq numbers can have a fixed maximum value MAX, and can be recycled by restarting the numbering, e.g., at zero after reaching MAX−1. A tool such as FIFO buffer 305 can accommodate an abrupt change in R_Seq associated with the restart of numbering. If FIFO buffer 305 has not been initialized, then flow proceeds to block 602 where the initialization occurs, and then flow proceeds to decision block 604. If initialization has already taken place, then flow skips block 602 and proceeds to decision block 604. In other words, block 602 is only executed once.

At decision block 604, it is determined if a packet has been received. If not, then receipt of a packet is awaited by looping through decision block 604. But if so, then flow proceeds to block 606, where at least some of the packet's metadata is read. For example, filter 504 reads enough of the metadata to find the marker for the R_Seq number and the R_Seq number itself.

From block 606, flow proceeds to decision block 608, where it is determined (e.g., based upon the R_Seq number in the metadata, as discussed above) if the packet is redundant to a packet that has already been received. If not, then flow proceeds to block 610, where the packet is retained. After block 610, flow proceeds to block 614 where the newly-received R_Seq number is stored in a FIFO manner to buffer 305. But if the R_Seq number is already present in FIFO 305, then flow proceeds to block 612, where the packet is discarded. From each of blocks 614 and 612, flow proceeds to the end at block 616.

Discussion of the messages in the sequence diagram of FIG. 5 now resumes. At message 527, filter 504 strips the R_Seq number (along with the marker bit pattern) from the culled packet. At message 528, filter 504 sends the reduced & culled packet to node N+1 (506) in the same (or substantially the same) form that it left node 502. At self-message 530, node N+1 (506) reconstructs (e.g., per TCP/IP functionality) the WRT/forwarded-WRT of message 510. It is noted that message 526 or messages 526-530 can occur alternatively before or after either of messages 522 and 524.

Messages 514-530 represent a loop 532, which is exited upon a copy of the last packet of the set (again, produced at message 512) being operated upon by node N+1 (506) at self-message 530. As such, self-message 530 begins reconstruction of the WRT/forwarded-WRT upon receiving the first packet of the set during a first iteration of loop 532 and finishes during a final iteration of loop 532.

In the examples provided above, the sets of packets could traverse the same physical path through the packetized networking infrastructure. Or the sets of packets could traverse separate paths having at least one physical difference (or, in other words, physically disparate paths) due to changes in the conditions of the packetized networking infrastructure related to differences in the points in time at which successive transmissions are initiated, as noted above.

Disparate physical paths might still not be physically disjoint (or, in other words, completely different physically). Such disparate (but not disjoint) physical paths (having at least one identified physical difference) might still have a significant number of common points of failure (CPsF). In the circumstance of a catastrophic disaster such as the terrorist attack upon New York City (NYC) in the United States on Sep. 11, 2001, disparate physical paths that had CPsF in the vicinity of the World Trade Center complex in (NYC) were knocked out. This delayed network disaster-recovery efforts for so long that many companies could not survive long enough to fully recover.

Accordingly, a network administrator might not be satisfied to rely upon the likelihood that the M+1 packet copy sets would traverse disparate physical paths between nodes N and N+1 of a sufficient degree of disparity to ensure that at least one packet set arrived. If so, then the network administrator could arrange for two or more tunnels comprised of physically disparate, or even disjoint, physical components. Of course, the more physically disparate tunnels are, the more expensive they are to obtain and/or maintain.

Physical components of tunnels can be analyzed in terms of CPsF. Suppose a tunnels T1 and T2 can be established between a node N and a node N+1. Each link or junction in tunnel can be described by the following data structure.
:<Owner_ID>.<Element_ID>.<comments>:

The field Owner_ID field can be a unique set of digits, e.g., 10 decimal digits, assigned to a company/corporation, municipality, organization or individual by a global standards body. The Element_ID can be an owner-unique set of digits, e.g., 10 decimal digits ) internally by the owner of the link/junction, e.g., cable number 12356. And the field “comments” can of fixed length, e.g., 200 ASCII characters, and user-defined content.

For example, suppose that company was assigned owner-ID #123, and that it owned all aspects of tunnel T1 included components numbered 1-11, then physical nature of tunnel T1 could uniquely be described as: 123.1, 123.2, 123.3, 123.4, 123.5, 123.6, 123.7, 123.8, 123.9, 123.10, 123.11. If component no. 1 of tunnel T1 is a link, then a data structure for component no. 1 could be as follows.
:123.1.Nine micron 1300 nm optical FC cable that begins at longitude X, latitude Y, altitude Z and ends at longitude A, latitude B altitude C by way of the RR track right of way known as XX:
   If component no. 2 of tunnel T1 was a junction, then a data structure for component no. 2 could be as follows.
:123.2.Ethernet Switch S/N 123456 in rack W of bay X of data center Y at address Z:

Returning to the example, suppose that a formula to characterize tunnel T1 is A+B+C+D+E+F+G+H+I+J+K (or just A,B,C,D,E,F,G,H,I,J,K) and that the formula for tunnel T1 is L,M,N,O,P,Q,R,S,T,U,V. A CPF analysis would reveal that there is no CPF between tunnels T1 and T2 because no element is shared between the two tunnel formulas. At the least rigorous level of assurance/cost, this may by sufficient.

Even without a CPF, if tunnels T1 and T1 both had components in lower Manhattan on Sep. 11, 2001, there could still have been a problem. Such a problem can be detected by performing a more rigorous Closest Point of Proximity (CPP) analysis. Continuing the example from above, if elements B and M are in the same room, in the same equipment bay, at the same height, 10 feet apart then a quantitative CPP analysis would reveal that the 3-dimentional (X,Y,Z) distance or CPP between them is 10 ft. A quantitative CPP study lists only the distance and does not give a context.

A quantitative and qualitative (Q²) CPP analysis considers additional Closest Common Point of Failure information. For instance, a quantitative CPP analysis could reveal that the CPP for tunnels T1 and T2 is 75 feet. This might sound very safe and lead a network administrator to believe that a failure or disaster that disrupts tunnel T1 is not likely to disrupt tunnel T2. However, had a Q²CPP analysis been performed, then the network administrator would know that both of tunnels T1 and T2 use cable troughs under the same bridge. If the bridge fails, both tunnels T1 and T2 would be lost.

Another more rigorous analysis Closest Common Point of Power Supply (CCPPS). For example, a blade/board in a chassis/box can be served by single or redundant power supplies with that box. Two blades in the same box may be elements of physically disparate tunnels. The box may have two separate power cables. The two power cables may go to the same or different outlets, on the same or different breakers, fed by the same or different power lines from the neighborhood substation (or from different substations), connected to the same (or different) regional power grid. At any point, a unique or shared UPS (un-interruptible power supply [e.g. batteries and/or generator]) or high priority Emergency-Power (E-power) backup power supply could also be connected. A CCPPS analysis would reveal whether such frailties exist in tunnels T1 and T2.

Of course, although several variances and example embodiments of the present invention are discussed herein, it is readily understood by those of ordinary skill in the art that various additional modifications may also be made to the present invention. Accordingly, the example embodiments discussed herein are not limiting of the present invention.

What is claimed:

1. A method of device-mirroring via a packetized networking infrastructure, the method comprising:
receiving, at a storage node N in a daisy-chained architecture, a write command from an entity representing a node N−1 in the daisy-chained architecture;
representing the write command as an original set of one or more packets;
making M copies of each packet of the original set;
sending each packet of the original set to a storage node N+1 in the daisy-chained architecture via the networking infrastructure; and
sending the M copies of each packet in the original set to the storage node N+1 via the networking infrastructure.

2. The method of claim 1, wherein one of the following sets of circumstances exist:
the node N−1 is a host that generates the write command,
the storage node N is a primary storage node with respect to the host, and
the storage node N+1 is a secondary storage node with respect to the storage node N; and
the node N−1 is primary storage node to an upstream host,
the node N is a secondary storage node with respect to the storage node N−1, and
the node N+1 is a tertiary storage node with respect to the storage node N.

3. The method of claim 1, further comprising:
generating, before sending a given packet of the original set and the M copies thereof, a sequence number; and
appending, before sending the given packet and the M copies thereof, the sequence number to each of the given packet and the M copies thereof.

4. The method of claim 1, wherein the packetized networking infrastructure is at least partially public.

5. The method of claim 4, further comprising:
receiving each packet of the original set before each packet of the original set is released to the public networking infrastructure; and
releasing each packet of the original set to the public networking infrastructure after the M copies of each packet in the original set are made.

6. The method of claim 4, wherein:
the storage node N is coupled to the public networking infrastructure via a packetized private networking infrastructure; and
the method further comprises
receiving each packet of the original set before each packet of the original set is released to the private networking infrastructure, and
releasing each packet of the original set to the private networking infrastructure after the M copies of each packet in the original set are made.

7. The method of claim 1, wherein:
the sending of a given packet in the original set includes using a first tunnel through the networking infrastructure;
the sending of the M copies of the given packet in the original set includes using at least a second tunnel through the networking infrastructure;
the first and second tunnels having at least one identified physical difference.

8. The method of claim 7, wherein the first and second tunnels have no common point of failure.

9. The method of claim 7, wherein the first and second tunnels are further characterized by having had at least one of a closest point of proximity analysis and a closest common point of power supply analysis performed thereon.

10. The method of claim 1, further comprising:
coordinating the sending of a given packet of the original set and the sending of the M copies thereof to commence at different points in time.

11. A device-mirroring daisy-chained architecture comprising:
a storage node N configured to store data and operable to
receive a write command from a node N−1, and
represent the write command as an original set of one or more packets;
a storage node N+1 daisy-chain-coupled via a networking infrastructure to, and configured to mirror data on, the node N; and
a networking-device operable to
make M copies of each packet in the original set;
send each packet of the original set to the storage node N+1 via the networking infrastructure; and
send the M copies of each packet in the original set to the storage node N+1 via the networking infrastructure.

12. The architecture of claim 11, wherein one of the following sets of circumstances applies:
the node N−1 is a host that generates the write command,
the storage node N is a primary storage node with respect to the host, and
the storage node N+1 is a secondary storage node with respect to the storage node N; and
the node N−1 is primary storage node to an upstream host,
the node N is a secondary storage node with respect to the storage node N−1, and
the node N+1 is a tertiary storage node with respect to the storage node N.

13. The architecture of claim 11, wherein the networking-device is further operable, before sending a given packet of the original set and the M copies thereof, to:
generate a sequence number; and
append the sequence number to the given packet and the M copies thereof.

14. The architecture of claim 11, wherein the packetized networking infrastructure is at least partially public.

15. The architecture of claim 14, wherein the networking-device is further operable to:
receive each packet of the original set before each packet of the original set is released to the public networking infrastructure; and
release each packet of the original set to the public networking infrastructure after the M copies of each packet in the original set are made.

16. The architecture of claim 14, wherein:
the storage node N is coupled to the public networking infrastructure via a packetized private networking infrastructure; and
the networking-device is further operable to
receive each packet of the original set before each packet of the original set is released to the private networking infrastructure, and
release each packet of the original set to the private networking infrastructure after the M copies of each packet in original set are made.

17. The architecture of claim 11, wherein:
the networking infrastructure includes at least a first and a second tunnel that have at least one identified physical difference with respect to each other; and
the networking-device is further operable to
send a given packet of the original set using the first tunnel, and
send the M copies of the given packet in the original set using at least the second tunnel.

18. The architecture of claim 17, wherein the first and second tunnels have no common point of failure.

19. The architecture of claim 18, wherein the first and second tunnels are further characterized by having had at least one of a closest point of proximity analysis and a closest common point of power supply analysis performed thereon.

20. The architecture of claim 11, wherein the networking device is further operable to commence sending a given packet of the original set and the M copies thereof at different points in time.

21. A method of device-mirroring via a packetized networking infrastructure, the method comprising:
receiving, via the networking infrastructure at a storage node N+1 in a daisy-chained architecture, a plurality of packets representing M+1 or fewer copies of a packet that is a member in a set of one or more packets, the set representing a forwarded write command sent from a storage node N in the daisy-chained architecture;
culling one packet from the plurality of packets; and
discarding as redundant the remainder of the plurality of packets.

22. The method of claim 21, further comprising:
recognizing a packet as redundant based, at least in part, upon whether metadata in the packet indicates the same sequence number as a previously-received packet.

23. The method of claim 21, further comprising:
accumulating one or more culled packets; and
reconstructing the forwarded write command from the accumulated one or more culled packets.

24. The method of claim 21, wherein of the following sets of circumstances exist:
the node N−1 is a host that generates the write command,
the storage node N is a primary storage node with respect to the host, and
the storage node N+1 is a secondary storage node with respect to the storage node N;
the node N−1 is primary storage node to an upstream host,
the node N is a secondary storage node with respect to the storage node N−1, and
the node N+1 is a tertiary storage node with respect to the storage node N.

25. The method of claim 21, wherein the packetized networking infrastructure is at least partially public.

26. A device-mirroring daisy-chained architecture comprising:
a filter operable to
receive, via a networking infrastructure, a plurality of packets representing M+1 or fewer copies of a packet that is a member in a set of one or more packets, the set representing a forwarded write command sent from the storage node N, and
cull one packet from the plurality of packets, and
discard as redundant the remainder of the plurality of packets;
a storage node N+1 daisy-chain-coupled via the networking infrastructure to, and configured to mirror data on, a node N, the storage node N+1 being operable to
accumulate at least one culled packet from the filter, and
reconstruct the forwarded write command from the accumulated at least one culled packet.

27. The architecture of claim 26, wherein the filter is further operable to recognize a packet as redundant based, at least in part, upon whether metadata in the packet indicates the same sequence number as a previously-received packet.

28. The architecture of claim 26, wherein one of the following sets of circumstances exist:
the node N−1 is a host that generates the write command,
the storage node N is a primary storage node with respect to the host, and
the storage node N+1 is a secondary storage node with respect to the storage node N; and
the node N−1 is primary storage node to an upstream host,
the node N is a secondary storage node with respect to the storage node N−1, and
the node N+1 is a tertiary storage node with respect to the storage node N.

29. The architecture of claim 26, wherein the packetized networking infrastructure is at least partially public.

30. An apparatus for device-mirroring via a packetized networking infrastructure, the apparatus comprising:
node N storage means, in a daisy-chained architecture, for storing data and for receiving a write command from an entity representing a node N−1 in the daisy-chained architecture;
means for transforming the write command into an original set of one or more packets;
means for copying each packet of the original set M times; and
output means for
sending each packet of the original set to node N+1 storage means in the daisy-chained architecture via the networking infrastructure, and
sending the M copies of each packet in the original set to the storage node N+1 via the networking infrastructure.

31. An apparatus for device-mirroring via a packetized networking infrastructure, the method comprising:
input means for receiving, via the networking infrastructure, a plurality of packets destined for node N+1 storage means in a daisy-chained architecture, the plurality of packets corresponding to M+1 or fewer copies of a packet that is a member in a set of one or more packets, the set representing a forwarded write command sent from a node N storage means in the daisy-chained architecture; and
filter means for
culling one packet from the plurality of packets, and
discarding the remainder of the plurality of packets.

32. The apparatus of claim 31 further comprising:
the node N+1 storage means;
wherein the filter means is further operable to send the culled packet to the node N+1 storage means; and
the node N+1 storage means is operable to
accumulate at least one culled packet from the filter means, and
reconstruct the forwarded write command from the at least one accumulated culled packet.
